(19) United States
(12) Patent Application Publication
(10) Pub. No.: US 2012/0027938 A1
(43) Pub. Date: Feb. 2, 2012

(54) CURED ELECTRODEPOSITION COATING FILM AND PROCESS FOR FORMING A MULTI LAYERED COATING FILM

(76) Inventors: Naotaka KITAMURA, Osaka (JP); Yoichiro Enoki, Osaka (JP); Tsutomu Shigenaga, Hiroshima-ken (JP)

(21) Appl. No.: 13/188,890

(22) Filed: Jul. 22, 2011

(30) Foreign Application Priority Data
Jul. 27, 2010 (JP) 2010-168334

(51) Int. Cl. C09D 163/02; C09D 133/00; B05D 3/02; C09D 7/12

(52) U.S. Cl. 427/372.2; 523/400; 523/467

(57) ABSTRACT

The present invention relates to a cured electrodeposition coating film which can be applied on a substrate such as an automobile body.

The cured electrodeposition coating film has a dynamic glass transition temperature of 105 to 120° C. and a crosslink density of 1.2×10⁻³ to 2.0×10⁻³ mole/cc, and phenol structural part represented with the formula: —C₆H₄—O— within a range of 0.12 to 0.24 mole in molar number based on a resin solid content of 100 g in the cured electrodeposition coating film. The cured electrodeposition coating film is obtained by conducting electrodeposition coating with a cationic electrodeposition coating composition, and then heating and curing it, wherein the cationic electrodeposition coating composition comprises, cationic epoxy resin (A) having bisphenol A-type structure in its molecule, cationic acrylic resin (B) obtainable by reacting an amino group containing compound with a copolymer obtainable by radical-copolymerization of a hydroxy group containing monomer, a glycidyl group containing monomer and another monomer, blocked isocyanate curing agent (C) which is obtained by blocking a cycloaliphatic isocyanate compound with an oxime compound, and a pigment.

### TECHNICAL FIELD

The present invention relates to a cured electrodeposition coating film which can be applied on a substrate such as an automobile body. More specifically, the present invention relates to a cured electrodeposition coating film having excellent corrosion resistance, as well as excellent weather resistance (including light resistance). The present invention further relates to a process for forming a multi layered coating film without applying an intermediate coating composition (so-called intermediate-coating-less system) for coating a substrate such as an automobile body.

### BACKGROUND ART

In general technological field of coating such as automobile coating, on a substrate such as steel plate, an electrodeposition coating film is formed and cured as an undercoating film for providing corrosion resistance, then an intermediate coating film is formed, and further top coating films including for example a colored base coating film and clear top coating are formed. In the technical field of coating such as automobile coating, however, decreasing and shortening coating step has been strongly required to attain resource saving, cost-saving and decreasing damage to environment (for example, VOC and HAPs etc.) lately.

A three coat one bake coating (3C1B) process is well known by skilled arts as a conventional step-shortened coating method. The 3C1B process includes the steps of: applying an intermediate coating composition, a base coating composition and a clear top coating composition on a cured electrodeposition coating film by wet on wet coating; and simultaneously baking and curing the three uncured coating films, which can provide multi layered coating film having three layers. The 3C1B process is enormously beneficial in energy saving and cost saving because the 3C1B process has only one heating and curing process for providing multi layered coating film. In addition, the multi layered coating film obtained from the 3C1B process includes an intermediate coating film, which can provide excellent hiding property, weather resistance, light resistance, impact resistance, chipping resistance and the like.

On the other hand, a process for forming a multi layered coating film without applying an intermediate coating composition (so-called intermediate-coating-less system) is considered as a highly-shortened coating process lately. In the conventional coating process including a step of applying an intermediate coating composition, the skilled arts require mainly corrosion resistance to an electrodeposition coating composition. However, a cured electrodeposition coating film generally requires complement of an intermediate coating film in case of forming multi layered coating film without intermediate coating film on an automobile body. In a coating process of intermediate-coating-less system, not only excellent corrosion resistance, but also excellent hiding property, weather resistance, light resistance, impact resistance and chipping resistance to a substrate are required in a cured electrodeposition coating film.

However, multi layered coating film having base coating film on a cured electrodeposition coating film which was formed by intermediate-coating-less system may provide time degradation. A presumed cause of the time degradation is ultraviolet radiation effect of the cured electrodeposition coating film without an intermediate coating film. The time degradation may cause serious damage in automobile coating because excellent weather resistance is required and appearance of coating film affects design properties of vehicles in automobile coating.

In addition, surface condition of the cured electrodeposition coating film greatly affects appearance of the multi layered coating film due to having no intermediate coating film in the intermediate-coating-less system. Thus the cured electrodeposition coating film in the intermediate-coating-less system requires more excellent surface condition.

Japanese Patent Kokai Publication No. 313495/2003 (patent literature 1) discloses a cationic electrodeposition coating composition comprising (A) an amino-containing epoxy resin obtained by the addition reaction of (a-2) an amino-containing compound to (a-1) an epoxy resin having an epoxy equivalent of 400-3,000, (B) an amino-containing acrylic resin obtained by the addition reaction of (b-4) an amino-containing compound to a copolymer resin obtained by radically copolymerizing a mixture containing (b-1) a polylactone-modified hydroxy-containing radically copolymerizable monomer prepared by the addition reaction of a lactone to (b) a hydroxy-containing acrylic monomer and (b-2) glycidyl (meth)acrylate as essential components and (b-3) other radically copolymerizable monomers, and (C) a blocked polyisocyanate curing agent as a curing component, wherein component (A) is present in an amount of 5-80 wt. %, component (B) is present in an amount of 5-80 wt. %, and component (C) is present in an amount of 10-40 wt. % each based on the total solids of components (A), (B), and (C) (claim 1). JP-A 313495/2003 discloses that the cationic electrodeposition coating composition provides excellent weather resistance, corrosion resistance, adhesion property, stability of the coating composition. On the other hand, JP-A 313495/2003 does not disclose ranges of a dynamic glass transition temperature or a crosslink density which can affect corrosion resistance of the coating film. JP-A 313495/2003 also has no description of phenol structural part in the present invention. Thus the present invention is different from the invention described in JP-A 313495/2003.

Japanese Kokai Patent Publication No. 292132/1998 (patent literature 2) discloses a cationic electrodeposition coating composition which is obtained by dispersing (a) an amine-modified polyphenol polyglycidyl ether-type epoxy resin, (b) an alicyclic blocked polyisocyanate curing agent, and if necessary, (c) an amino group-containing acrylic copolymer in an aqueous medium containing a neutralizer at such a ratio of the component (a) to component (b) that the cured coating film exhibits an extensibility of 3% or lower, a dynamic glass-transition temperature of 110° C. or higher, and a crosslink density of 1.2×10⁻³ mol/cm³ or less. On the other hand, JP-A 292132/1998 discloses the crosslink density of 1.2×10⁻³ mol/cm³ or less, which is different from the range according to the present invention. In addition, JP-A 292132/1998 discloses that difference between a solubility parameter of component A and a solubility parameter of component C is greater than 0.5 (claim 4), which is different from the range according to the present invention.

### PATENT LITERATURE

Patent literature 1: JP-A 313495/2003

Patent literature 2: JP-A 292132/1998

### SUMMARY OF INVENTION

The present invention has an object to solve the above technological problem. More specifically, a main object of the present invention is to provide a cured electrodeposition coating film having excellent corrosion resistance, as well as excellent weather resistance, which can be preferably used in a process for forming a multi layered coating film without applying an intermediate coating composition (so-called intermediate-coating-less system).

The present invention relates to a cured electrodeposition coating film having a dynamic glass transition temperature of 105 to 120° C. and a crosslink density of 1.2×10⁻³ to 2.0×10⁻³ mole/cc, which is obtained by conducting electrodeposition coating with a cationic electrodeposition coating composition, and then heating and curing it, wherein

the cured electrodeposition coating film has phenol structural part represented with the formula: —C₆H₄—O— within a range of 0.12 to 0.24 mole in molar number based on a resin solid content of 100 g in the cured electrodeposition coating film,

the cationic electrodeposition coating composition comprises,

a cationic epoxy resin (A) having bisphenol A-type structure in its molecule,
a cationic acrylic resin (B) obtainable by reacting an amino group containing compound with a copolymer obtainable by radical-copolymerization of a hydroxy group containing monomer, a glycidyl group containing monomer and another monomer,
blocked isocyanate curing agent (C) which is obtained by blocking a cycloaliphatic isocyanate compound with an oxime compound, and
a pigment, and wherein

the cationic electrodeposition coating composition comprises 30 to 50 parts by weight of the cationic epoxy resin (A), 20 to 40 parts by weight of the cationic acrylic resin (B) and 30 to 35 parts by weight of the curing agent (C) in the ratio based on a resin solid content in the cationic electrodeposition coating composition,

the cationic epoxy resin (A) has a number average molecular weight of 2000 to 3000 and a glass transition temperature of 28 to 50° C., and the cationic acrylic resin (B) has a number average molecular weight of 5000 to 6000 and a glass transition temperature of 28 to 50° C., and a solubility parameter 5A of the cationic epoxy resin (A) and a solubility parameter 5B of the cationic acrylic resin (B) have a relationship represented by the following formula:

|δA−δB|<0.3, and

a solubility parameter δC of the blocked isocyanate curing agent (C) and the solubility parameters have a relationship represented by the following formulae:

|δC−δA|<1.0 and |δC−δB|<1.0,

which can resolve the above technological problem.

The cationic epoxy resin (A) may preferably have phenol structural part represented with the formula: —C₆H₄—O— within a range of 0.35 to 0.55 mole in molar number based on a resin solid content of 100 g in the cationic epoxy resin (A).

The cationic electrodeposition coating composition may preferably further comprise 1 to 2 parts by weight of a silicate compound (D) based on the resin solid content of 100 g in the cationic electrodeposition coating composition.

The present invention further comprises a process for forming a multi layered coating film comprising the steps of:

applying a base coating composition on the above cured electrodeposition coating film to form an uncured base coating film,

applying a clear top coating composition on the uncured base coating film to form an uncured clear top coating film, and

simultaneously heating and curing the uncured base coating film and the uncured clear top coating film.

A cured electrodeposition coating film according to the present invention is characterized by excellent corrosion resistance and excellent weather resistance. The present invention has characteristics of the controlled range of amount of phenol structural part in a cured electrodeposition coating film, and of specific range of physical properties. The characteristics can achieve both the properties of excellent corrosion resistance and excellent weather resistance. A cured electrodeposition coating film according to the present invention can be preferably used in a process for forming a multi layered coating film without applying an intermediate coating composition (so-called intermediate-coating-less system).

### DESCRIPTION OF EMBODIMENTS

An ordinary cured electrodeposition coating film obtained by electrodeposition coating is commonly used for undercoating film thanks to its excellent corrosion resistance. It is because an electrodeposition coating composition contains an epoxy resin having aromatic ring structure as a binder resin, which provides strong cured coating film having blocking ability for permeation of oxygen, water or ion components after heating and curing. In addition, the cured electrodeposition coating film has excellent adhesion property on materials of steel plate. On the other hand, the aromatic ring structure has disadvantage of deterioration under light (ultraviolet) radiation. Thus, using an epoxy resin having a lot of aromatic ring structure as a binder resin can provide excellent corrosion property and poor weather resistance (including light resistance) concurrently.

The way for improving weather resistance of cured electrodeposition coating film obtained by an cationic electrodeposition coating composition includes the use of additional resin having excellent weather resistance such as acrylic resin or polyester resin concomitantly with an epoxy resin. However such the way of concomitant use of additional resin relatively decreases the amount of the epoxy resin, which provides poor corrosion resistance. Thus achieving an excellent balance between corrosion resistance and weather resistance required in intermediate-coating-less system has been very difficult for those skilled arts.

The present invention relates to a cured electrodeposition coating film which may be preferably used in a process for forming a multi layered coating film having base coating film on a cured electrodeposition coating film (so-called intermediate-coating-less system). In the present invention, the inventors have paid attention to an amount of phenol structural part represented with the formula: —C₆H₄—O— in the cured electrodeposition coating film. They have found that the amount of phenol structural part in the cured electrodeposition coating film can be controlled by using the specific amounts of the components of a cationic epoxy resin (A), a cationic acrylic resin (B) and blocked isocyanate curing agent (C) having specific structure, which provides accomplishment of excellent weather resistance. In addition, the use of the specific amounts of the components (A), (B) and (C) also results in the cured electrodeposition coating film having specific range of physical properties, which provides accomplishment of excellent corrosion resistance. In the present invention, the use of the specific amounts of the specific components (A), (B) and (C) can thus achieve a cured electrodeposition coating film having both the properties of excellent corrosion resistance and excellent weather resistance which is resulted from its resin structure and physical properties.

### Cationic Electrodeposition Coating Composition

The cationic electrodeposition coating composition according to the present invention contains:

a cationic epoxy resin (A) having bisphenol A-type structure in its molecule,

a cationic acrylic resin (B) obtainable by reacting a amino group containing compound with a copolymer obtainable by radical-copolymerization of a hydroxy group containing monomer, a glycidyl group containing monomer and another monomer,

blocked isocyanate curing agent (C) which is obtained by blocking a cycloaliphatic isocyanate compound with oxime compounds, and

a pigment. Details of the above components are as follows.

Cationic Epoxy Resin (A)

In the present invention, a cationic epoxy resin (A) in an electrodeposition coating film as a film-forming resin has bisphenol A-type structure in its molecule, which is prepared by opening epoxy rings in a molecule of the epoxy resin containing at least a bisphenol A-type epoxy resin by the reaction with an amino group containing compound such as primary amine, secondary amine and an acid salt of tertiary amine.

A typical example of the epoxy resin used in the preparation of the cationic epoxy resin (A) is polyphenol polyglycidyl ether-type epoxy resin having bisphenol A-type structure. The polyphenol polyglycidyl ether-type epoxy resin includes, for example, reaction product of bisphenol A and epichlorohydrin. In preparation of the polyphenol polyglycidyl ether-type epoxy resin, polycyclic phenol compound such as bisphenol F, bisphenol S, phenol novolak or cresol novolak may be used and reacted with epichlorohydrin, in combination with bisphenol A. In addition, hydrogenerated-modified compounds of the polycyclic phenol compounds (including bisphenol A) may be used in combination with bisphenol A.

Another example of the epoxy resin which may be used in preparation of cationic epoxy resin (A) includes an epoxy resin having an oxazolidone ring described in Japanese Patent Kokai Publication No. 306327/1993 (JP-A 306327/1993). The epoxy resin can be obtained by reacting a blocked isocyanate curing agent (obtained by blocking an NCO group of a diisocyanate compound with lower alcohol, such as methanol or ethanol) with polyepoxide in the presence of base catalyst under heating, and removing generated lower alcohol (blocking agent) from the reaction system. JP-A 306327/1993 is a priority patent application of U.S. Pat. No. 5,276,072, which is herein incorporated by reference.

The above epoxy resin may be chain-extended by using difunctional polyester polyol, polyether polyol, bisphenol, dibasic carboxylic acid and the like, prior to the ring-opening reaction of epoxy rings with an amino group containing compound. Similarly, a monohydroxyl compound such as 2-ethylhexanol, nonyl phenol, ethylene glycol mono-2-ethylhexylether, ethylene glycol mono-n-butylether diethylene glycol mono-n-butyl ether and propylene glycol mono-2-ethylhexylether, or acid component such as stearic acid, 2-ethyl hexanoic acid and dimer acid can also be added to a part of epoxy rings, prior to the ring-opening reaction of epoxy rings with the an amino group containing compound, in order to control molecular weight or amine equivalent and to improve heat flow property, flexibility, or a glass transition temperature etc. Similarly, the above-described polycyclic phenol compounds can also be added thereto.

Examples of the amino group containing compound, which can be used for ring-opening an epoxy group and introducing an amino group thereto, include primary amine, secondary amine, or an acid salt of tertiary amine, such as butylamine, octylamine, diethylamine, dibutylamine, methylbutylamine, monoethanolamine, diethanolamine, N-methylethanolamine, an acid salt of triethylamine and an acid salt of N,N-dimethylethanolamine and so on. A secondary amine having ketimine blocked primary amino group, such as diethylenetriamine diketimine, aminoethylethanolamine ketimine and aminoethylethanolamine methylisobutylketimine can be also used. In order to ring-open all epoxy rings, it is required to react the amines with epoxy rings in at least equivalent amount.

The cationic epoxy resin (A) may preferably have a number average molecular weight of 2,000 to 3,000. When the number average molecular weight is lower than 2,000, the physical properties of the resulting cured coating film, such as solvent resistance and corrosion resistance may be poor. On the other hand, when the number average molecular weight is greater than 3,000, flow property on curing under applied heat may be poor, which may degrade appearance of the resulting coating film. In the present invention, a number average molecular weight of a resin component can be measured by GPC (gel permeation chromatography) with the use of corresponding value of styrene standards.

The cationic epoxy resin (A) may preferably have phenol structural part represented with the formula: —C₆H₄—O— within a range of 0.35 to 0.55 mole in molar number based on a resin solid content of 100 g in the cationic epoxy resin (A), more preferably 0.35 to 0.47 mole in molar number. The cationic epoxy resin (A) has bisphenol A-type structure in its molecule. For example, 228.29 g of bisphenol A has 2 mole of phenol structural part represented with the formula: —C₆H₄—O—. The way for adjusting an amount of phenol structural part represented with the formula: —C₆H₄—O— within a range of 0.35 to 0.55 mole in molar number based on a resin solid content of 100 g in the cationic epoxy resin (A) includes, for example: varying an amounts of using components such as polycyclic phenol compounds or hydrogenerated-modified compounds of the polycyclic phenol compounds, or chain-extending of the cationic epoxy resin by reacting resultant epoxy resin with polycyclic phenol compounds, and the like, in the preparation of the cationic epoxy resin (A).

When the molar number of phenol structural part represented with the formula: —C₆H₄—O— based on a resin solid content of 100 g in the cationic epoxy resin (A) is lower than 0.35 mole, blocking ability for permeation of oxygen, water or ion components in a cured electrodeposition coating film and adhesion property of the coating film on materials of steel plate may be deteriorated, which may result in deterioration of corrosion resistance. When the molar number is greater than 0.55 mole, weather resistance of the cured electrodeposition coating film may be deteriorated. The molar number based on a resin solid content of 100 g can be measured by calculation of amounts of ingredients.

The cationic epoxy resin (A) may preferably have a glass transition temperature Tg(A) of 28 to 50° C., more preferably 30 to 40° C. When the glass transition temperature Tg(A) is lower than 28° C., corrosion resistance may be poor because a dynamic glass transition temperature of a cured electrodeposition coating film required in corrosion property cannot be obtained. On the other hand, when the glass transition temperature Tg(A) is higher than 50° C., cohesion property in electrodeposition coating process may be poor, which may degrade film appearance of a cured electrodeposition coating film. The glass transition temperature of the cationic epoxy resin (A) can be measured by a differential scanning calorimeter.

Cationic Acrylic Resin (B)

In the present invention, a cationic acrylic resin (B) in an electrodeposition coating film as a film-forming resin is a component which can provide weather resistance, light resistance, impact resistance, chipping resistance and the like for the resultant cured electrodeposition coating film. The cationic acrylic resin (B) can be obtainable by reacting an amino group containing compound with a copolymer obtainable by radical-copolymerization of a hydroxy group containing monomer, a glycidyl group containing monomer and another monomer.

The hydroxy group containing monomer which can be used for preparing the cationic acrylic resin (B) includes, for example, 2-hydroxyethyl (meth)acrylate, 2-hydroxypropyl (meth)acrylate, 4-hydroxybutyl (meth)acrylate, 2-hydroxymethyl (meth)acrylate and addition products formed by reacting the hydroxy group containing monomer(s) with e-caprolactone, and the like. The hydroxy group containing monomer may be used with alone or a combination of two or more monomers.

The glycidyl group containing monomer includes, for example, glycidyl (meth)acrylate, (meth) allylglycidylether, and the like. The glycidyl group containing monomer may be used with alone or a combination of two or more monomers.

The another monomer includes, for example, acrylic monomers such as methyl(meth)acrylate, ethyl(meth)acrylate, n-propyl(meth)acrylate, isopropyl(meth)acrylate, n-butyl(meth)acrylate, isobutyl(meth)acrylate, t-butyl(meth)acrylate, cyclohexyl(meth)acrylate, 2-ethylhexyl(meth)acrylate, lauryl(meth)acrylate and isobornyl(meth)acrylate; non-acrylic monomers such as styrene, vinyl toluene, α-methylstyrene, (meth)acrylonitrile, (meth)acrylamide and vinyl acetate; and the like. The another monomer may be used with alone or a combination of two or more monomers.

The hydroxy group containing monomer, the glycidyl group containing monomer and another monomer are radical-copolymerized to obtain an acrylic copolymer. An amount of the hydroxy group containing monomer may preferably be in the range such that the cationic acrylic resin (B) has hydroxyl value of 100 to 250, more preferably 170 to 220. An amount of the glycidyl group containing monomer may preferably be in the range such that the cationic acrylic resin (B) has amino group of 80 to 150 mg, more preferably 90 to 110 mg, based on 100 g of the cationic acrylic resin (B). The hydroxyl value can be measured by calculation of amounts of the hydroxy group containing monomer.

An oxirane ring-containing acrylic resin of the resultant acrylic copolymer can be converted into the cationic acrylic resin (B) by opening oxirane rings in the acrylic copolymer by the reaction with amino group containing compound such as primary amine, secondary amine or an acid salt of tertiary amine. The amino group containing compounds described in the preparation of the cationic epoxy resin (A) can be used as the amino group containing compound for the opening oxirane rings.

Another method for preparing the cationic acrylic resin (B) includes, for example, copolymerizing amino group containing acrylic monomer and another monomer to obtain cationic acrylic resin (B) directly. In the method, the glycidyl group containing monomer is replaced with amino group containing acrylic monomer, such as N,N-dimethylaminoethyl (meth)acrylate, and N,N-di-t-butylaminoethyl (meth)acrylate, and the cationic acrylic resin (B) can be obtained by copolymerizating the amino group containing acrylic monomer, the hydroxyl group containing acrylic monomer and another acrylic monomer and/or non-acrylic monomer.

The resulting cationic acrylic resin (B) may be self-crosslinkable acrylic resin which may be obtained by incorporating a blocked isocyanate group to the acrylic polymer backbone by an addition reaction with a half-blocked diisocyanate compound, as described in Japanese Patent Kokai Publication No. 333528/1996 (JP-A 333528/1996).

The cationic acrylic resin (B) may preferably have a number average molecular weight of 5,000 to 6,000. When the number average molecular weight is lower than 5,000, the physical properties of the resulting cured coating film, such as solvent resistance may be poor. On the other hand, when the number average molecular weight is greater than 6,000, flow property on curing under applied heat may be poor, which may degrade appearance of the resulting coating film. In the present invention, a number average molecular weight of a resin component can be measured by GPC (gel permeation chromatography) with the use of corresponding value of styrene standards. The cationic acrylic resin (B) may be used with alone or a combination of two or more in order to balance its film performance.

The cationic acrylic resin (B) may preferably be designed to have hydroxyl value of 100 to 250, more preferably 170 to 220. When the hydroxyl value is lower than 100, the curing ability of the resulting coating film may be degraded. On the other hand, when the hydroxyl value is greater than 250, excess hydroxyl groups may remain in the coating film after curing, which may degrade water resistance.

The cationic acrylic resin (B) may preferably have a glass transition temperature Tg(B) of 28 to 50° C., more preferably 30 to 40° C. When the glass transition temperature Tg(B) is lower than 28° C., corrosion resistance may be poor because a dynamic glass transition temperature of a cured electrodeposition coating film required in corrosion property cannot be obtained. On the other hand, when the glass transition temperature Tg(B) is higher than 50° C., cohesion property in electrodeposition coating process may be poor, which may degrade film appearance of a cured electrodeposition coating film. The glass transition temperature of the cationic acrylic resin (B) can be measured by a differential scanning calorimeter.

Blocked Isocyanate Curing Agent (C)

In the present invention, a blocked isocyanate curing agent (C) obtained by blocking a cycloaliphatic isocyanate compound with an oxime compound is used as a curing agent.

In the process for preparing the blocked isocyanate curing agent(C), a cycloaliphatic isocyanate compound is used to improve weather resistance. The cycloaliphatic isocyanate compound includes, for example, cycloaliphatic diisocyanate having 5 to 18 carbon atoms such as 1,4-cyclohexane diisocyanate (CDI), isophorone diisocyanate (IPDI), 4,4′-dicyclohexylmethane diisocyanate (hydrogenated MDI), methylcyclohexane diisocyanate, isopropylidene dicyclohexyl-4,4′-diisocyanate, 1,3-diisocyanatomethylcyclohexane (hydrogenated XDI), hydrogenated TDI, 2,5- or 2,6-bis(isocyanatomethyl) bicyclo[2.2.1]heptane (norbornane diisocyanate); modified compounds of the cycloaliphatic diisocyanate such as urethane, carbodiimide, uret-dione, uretone-imine, burette and/or isocyanurate-modified compound. The cycloaliphatic isocyanate compound may be used with alone or a combination of two or more compounds. Adducts or prepolymers obtained by reacting the cycloaliphatic isocyanate with polyalcohols such as ethylene glycol, propylene glycol, trimethylolpropane and hexanetriol at a NCO/OH ratio of not less than 2 may be used as the blocked isocyanate curing agent.

In the process for preparing the blocked isocyanate curing agent(C), an oxime compound is used as block agents for blocking the cycloaliphatic isocyanate compound. The block agents are adducted to the cycloaliphatic isocyanate compound and function to stable at room temperature, but free isocyanate group can be regenerated when heating it at the temperature not less than its dissociation temperature.

The oxime compound includes, for example, formaldehydroxime, acetaldehydroxime, acetoxime, methylethyl ketoxim, diacetyl monoxime, cyclohexane oxime, and the like. In the process for preparing the blocked isocyanate curing agent(C), the use of the oxime compounds as block agents has advantages that blocking ability for permeation of gas is improved to obtain excellent corrosion resistance. Thus the use of the blocked isocyanate curing agent (C) which is obtained by blocking the cycloaliphatic isocyanate compound with the oxime compound provides a cured electrodeposition coating film having both the properties of excellent corrosion resistance and excellent weather resistance.

The above components (A) to (C) are resin solid components in the cationic electrodeposition coating composition. An amount of the components in the cationic electrodeposition coating composition are 30 to 50 parts by weight of the cationic epoxy resin (A), 20 to 40 parts by weight of the cationic acrylic resin (B) and 30 to 35 parts by weight of the curing agent (C) in the ratio based on a resin solid content in the cationic electrodeposition coating composition. When the amount of the cationic epoxy resin (A) is lower than 30 parts by weight, blocking ability for permeation of oxygen, water or ion components may be deteriorated and adhesion property of the coating film on materials of steel plate may be deteriorated. When the amount of the cationic epoxy resin (A) is greater than 50 parts by weight, an amount of phenol structural part in the cured electrodeposition coating film may be excess amount to deteriorate weather resistance. When the amount of the cationic acrylic resin (B) is lower than 20 parts by weight, an amount of phenol structural part in the cured electrodeposition coating film may be excess amount relatively to deteriorate weather resistance. When the amount of the cationic acrylic resin (B) is greater than 40 parts by weight, blocking ability for permeation of oxygen, water or ion components may be deteriorated and adhesion property of the coating film on materials of steel plate may be deteriorated. When the amount of the blocked isocyanate curing agent (C) is lower than 30 parts by weight, the curing of the coating film may be degraded and the physical properties of the coating film such as mechanical strength may be degraded. In addition, deterioration of film appearance due to attack of a base coating composition on coating may be generated. When the amount of the blocked isocyanate curing agent (C) is greater than 35 parts by weight, the coating film may be overcured and the physical properties of the coating film such as impact resistance are degraded.

In the present invention, a solubility parameter δA of the cationic epoxy resin (A) and a solubility parameter δB of the cationic acrylic resin (B) have a relationship represented by the following formula:

|δA−δB|<0.3, and

a solubility parameter δC of the blocked isocyanate curing agent and the parameters have a relationship represented by the following formulae:

|δC−δA|<1.0 and |δC−δB|<1.0.

The term “solubility parameter δ” as used herein is generally called by persons skilled in the art as SP, which shows a measuring criterion indicating degree of hydrophilicity or hydrophobicity and is an important criterion to consider compatibility between resins. A value of solubility parameter can be determined by a method called as turbidimetric method, which is well known to the art (K. W. Suh, D. H. Clarke J. Polymer Sci., A-1,5,1671 (1967)). The solubility parameter 5 used herein is the parameter measured by the turbidimetric method. The solubility parameter in the turbidimetric method can be measured by e.g., dissolving a specific amount by weight of resin in specific amount of good solvent such as acetone; adding poor solvent to the solution to precipitate the resin; measuring the amount of adding poor solvent until suspension occurs; calculating solubility parameter with the measurement value based on well known mathematical formula described in the above Reference.

When the difference in solubility parameter between each resins goes over 0.4, both the resins start to show less-compatible with each other, and the resultant coating film starts to exhibit self-stratifying structure. In the present invention, the difference of a solubility parameter δA of the cationic epoxy resin (A) and a solubility parameter δB of the cationic acrylic resin (B) is less than 0.3, which provides stable compatibility of the cationic epoxy resin (A) and the cationic acrylic resin (B). The stable compatibility of the components (A) and (B) results in uniformity of the components, which lowers internal stress of the coating film and improves chipping resistance and adhesion property. When the difference of a solubility parameter is greater than or equal to 0.3, compatibility of the components (A) and (B) may be deteriorated and poor appearance of the cured coating film such as cissing may be obtained. In addition, internal stress may be increased, which may deteriorate chipping resistance and adhesion property.

The solubility parameter δC of the blocked isocyanate curing agent is important in terms of curing of the cationic epoxy resin (A) and the cationic acrylic resin (B). In the present invention, a solubility parameter δC of the blocked isocyanate curing agent and the solubility parameters δA and δB have a relationship represented by the following formulae:

|δC−δA|<1.0 and |δC−δB|<1.0.

When the solubility parameters δA, δB and δC of the components (A), (B) and (C) satisfy the above relationship, curing of the cationic epoxy resin (A) and the cationic acryl resin (B) may preferably be excellent to obtain a cured electrodeposition coating film having excellent corrosion resistance and weather resistance.

Pigment

The cationic electrodeposition coating composition used in the present invention may contain pigment, which has been conventionally used for a coating. Examples of the pigments include, for example, a coloring pigment, such as carbon black, titanium dioxide and graphite; an extender pigment, such as kaolin, aluminum silicate (clay) and talc; a rust preventive pigment, such as, aluminum phosphomolybdate, lead silicate, lead sulfate, zinc chromate and strontium chromate. However, in the present invention, the following silicate compound (D) must not be included in the pigment. In these pigments, titanium dioxide, aluminum silicate (clay) and aluminum phosphomolybdate may preferably be used. Especially, titanium dioxide may most preferably be used in the cationic electrodeposition coating composition because titanium dioxide has excellent hiding property in the coloring pigments and is available at an affordable price. The pigment may be used with alone, and may generally be used a combination of two or more in order to balance its film performance.

The pigment may preferably be generally pre-dispersed in an aqueous solvent at high concentration in the form of a paste (pigment dispersed paste), and the resultant paste may be added in the cationic electrodeposition coating composition. This is because it is difficult to uniformly disperse the pigment, which is powdery, at low concentration in one step. The paste is generally called as pigment dispersed paste.

The pigment dispersing paste is prepared by dispersing the pigment together with pigment dispersing resin in an aqueous medium. As the pigment dispersing resin, cationic or non-ionic low molecular weight surfactant, or cationic polymer such as modified epoxy resin having quaternary ammonium group and/or tertiary sulfonium group can be used. As the aqueous medium, deionized water or water containing a small amount of alcohol can be used. The pigment dispersing paste may generally contain 5 to 40 parts by weight of the pigment dispersing resin and 10 to 30 parts by weight of the pigment at the solid content ratio. The pigment dispersing paste can be obtained by mixing the pigment dispersing resin with the pigment, and dispersing the pigment using a suitable dispersing apparatus, such as a ball mill or sand grind mill, to become homogeneous particle size of the pigment.

An amount of the pigment may preferably be within the range of 5 to 50 parts by weight based on a resin solid content of 100 g in the cationic electrodeposition coating composition. When the amount is lower than 5 parts by weight, blocking ability for permeation of oxygen, water or ion components may be deteriorated and excellent corrosion resistance may not be obtained because of shortage of the amount of the pigment. On the other hand, when the amount is greater than 50 parts by weight, flow property when curing with heating may be poor on curing under applied heat to degrade appearance of the resulting coating film.

Silicate Compound (D)

The cationic electrodeposition coating composition used in the present invention may preferably contain silicate compound (D). In the present invention, silicate compound (D) means a compound which elutes silicate ion in an aqueous alkaline solution, more specifically, a compound which elutes 50 ppm to 3000 ppm, preferably not less than 100 ppm in equilibrium concentration, of silicate ion in an aqueous alkaline solution contained 1% by weight of the compound. Adding the silicate compound (D) in the cationic electrodeposition coating composition can provide a cationic electrodeposition coating composition preferably used for coating of a corrosion-prone substrate in a strong alkaline solution. When the equilibrium concentration of eluted silicate ion is lower than 50 ppm, technical effect of corrosion resistance for the addition of the silicate compound (D) may not be obtained. The equilibrium concentration of silicate ion can be measured by fluorescent X-ray spectroscopy as a corresponding value in a calibration curve method.

General compounds having silicate component include ordinary pigments for coating composition. On the other hand, the silicate compound (D) according to the present invention is limited to the compound which elutes 50 ppm to 3000 ppm in equilibrium concentration of silicate ion in an aqueous alkaline solution, and another compounds are classified into pigments. That is, compounds having silicate component but not having the ability for eluting silicate ion in the above equilibrium concentration are not included in the “silicate compound (D)” in the present invention. The silicate compound (D) includes, for example, zinc silicate, calcium silicate and silica and the like. The term “silica” generally means a solid material mainly consisted of silicon dioxide. However, the ability for eluting silicate ion of silica seems to vary depending on its formation and the like. In the present invention, porous silica particle may preferably be used for the silicate compound (D). The porous silica particle has a lot of internal surface area, which can provide a lot of elution of silicate ion. The porous silica particle includes, for example, Sylysia available commercially by Fuji Silysia Chemical Inc., which is produced by a wet process in mixing silicate soda and acid components.

The silicate compound (D) may be pre-dispersed in an aqueous solvent using the above mentioned pigment dispersing resin in the form of a paste (dispersed paste), and the resultant paste may be added in the cationic electrodeposition coating composition, the same as the pigment. In the preparation of the dispersed paste, the silicate compound (D) may be used together with the pigment in the preparation of the pigment dispersed paste. In case that the silicate compound (D) is used for the preparation of the cationic electrodeposition coating composition, am amount of the silicate compound (D) may preferably be within the range of 1 to 2 parts by weight based on 100 parts by weight of the total solid content of the cationic electrodeposition coating composition. When the amount of the silicate compound (D) is greater than 2 parts by weight, stability of the dispersed paste may be deteriorated.

Other Components

The cationic electrodeposition coating composition may optionally contain catalyst for dissociation of the block agent from the blocked polyisocyanate curing agent. The catalyst includes, for example, organic tin compounds such as dibutyltin dilaurate, dibutyltin oxide, dioctyltin oxide; amines such as N-methyl morpholine; metal salts of strontium, cobalt and cupper; in order to dissociate the block agent in addition to the above components. The amount of the catalyst may preferably be from 0.1 to 6 parts by weight based on 100 parts by weight of the total solid content of the cationic epoxy resin and blocked isocyanate curing agent in the cationic electrodeposition coating composition. The cationic electrodeposition coating composition may optionally contain conventional additives for a coating composition such as plasticizing agent, surfactant, surface smoothing agent, antioxidizing agent and ultraviolet absorbing agent and the like.

Preparation of Cationic Electrodeposition Coating Composition

The cationic electrodeposition coating composition according to the present invention contains at least the above cationic epoxy resin (A), cationic acrylic resin (B), blocked isocyanate curing agent(C) and pigment. The cationic electrodeposition coating composition according to the present invention can be prepared by dispersing the above components and optional other components such as the silicate compound (D) and additives in an aqueous solvent containing a neutralizing acid to make emulsion(s), then mixing the resultant emulsion(s) such that the amounts of the components (A) to (C) satisfy the above range of the present invention. Examples of the neutralizing acid includes, for example, inorganic acids such as hydrochloric acid, nitric acid, phosphoric acid, and organic acids such as formic acid, acetic acid, lactic acid, sulfamic acid and acetyl glycine acid.

In the preparation of the cationic electrodeposition coating composition, an emulsion containing the cationic epoxy resin (A) and the blocked isocyanate curing agent(C), and another emulsion containing the cationic acrylic resin (B) and the blocked isocyanate curing agent(C) may preferably be prepared preliminarily, then these emulsions be mixed with other components. In another preparation method, the epoxy resin (A) and the cationic acrylic resin (B) having emulsion form may be dispersed directly in aqueous solution to make an emulsion. Furthermore, the components may be neutralized with use of organic acids such as formic acid, acetic acid, lactic acid in an amount such that amino groups in the components can be neutralized, to disperse the components as a cationic emulsion in aqueous solution.

The cationic electrodeposition coating composition may contain organic solvent conventionally used in coating compositions, for example, ethylene glycol monobutyl ether, ethylene glycol monohexyl ether, ethylene glycol monoethylhexyl ether, propylene glycol monobutyl ether, dipropylene glycol monobutyl ether, propylene glycol monophenyl ether and the like.

The cationic electrodeposition coating composition according to the present invention may preferably have solid content of 15 to 25 parts by weight. The solid content can be controlled with use of aqueous solution (either only water or mixtures of water and an organic solvent having affinity for water).

### Preparation of Cured Electrodeposition Coating Film

A cured electrodeposition coating film can be obtained by conducting an electrodeposition coating and then heating and curing the resultant electrodeposition coating film. Electrodeposition coating is carried out by applying a voltage of usually 100 to 400 V between a conductive substrate serving as cathode and an anode at a bath temperature of the cationic electrodeposition coating composition within the range of 15 to 35° C., to obtain an uncured electrodeposition coating film having dried film thickness of 13 to 20 μm. Then, the resultant uncured electrodeposition coating film is heated at temperature in the range of 140 to 200° C., preferably 160 to 180° C., for 10 to 30 minutes to obtain a cured electrodeposition coating film.

The substrate on which the cured electrodeposition coating film is applied is not limited as long as it has conductive property. Examples of the substrate include, for example, metals such as iron, steel, copper, aluminum, magnesium, tin, zinc and the like, and alloys thereof, and steel plate, copper plate, aluminum plate, and deposited articles thereof (e.g., chemical conversion treatment such as phosphoric salt or zirconium salt), as well as molded articles thereof.

In the present invention, a dynamic glass transition temperature of the cured electrodeposition coating film obtained by electrodeposition coating is within the range of 105 to 120° C. When the dynamic glass transition temperature of the cured electrodeposition coating film is lower than 105° C., blocking ability for permeation of oxygen, water or ion components may be deteriorated and corrosion property may be poor. On the other hand, when the dynamic glass transition temperature of the cured electrodeposition coating film is greater than 120° C., elastic modulus of the cured electrodeposition coating film may be lowered and impact resistance of the resultant multilayered coating film may be deteriorated. Examples for controlling the range of the dynamic glass transition temperature include, for example, using a cationic epoxy resin (A) having a glass transition temperature of 28 to 50° C., a cationic acrylic resin (B) having a glass transition temperature of 28 to 50° C., and blocked isocyanate curing agent(C) obtained by blocking a cycloaliphatic isocyanate compound in the amounts of the above-mentioned range according to the present invention.

The dynamic glass transition temperature of the cured electrodeposition coating film can be measured using a measurement sample by a method similar to conventional dynamic viscoelastic measurement for measuring Tg. A concrete method for measuring the glass transition temperature includes, for example, making a cured electrodeposition coating film on a substrate, removing off the coating film with mercury, and cutting to prepare samples for determination of the dynamic glass transition temperature. In the method, viscoelasticity is determined by raising form room temperature to 200° C. in temperature rate of 2° C. per a minute, and a vibrated at a frequency of 11 Hz. Then, A ratio (tan δ) of loss elasticity (E″)/storage elasticity (E′) is calculated and its inflexion point is determined to obtain a dynamic glass transition temperature. A measurement device for measuring a dynamic glass transition temperature includes, for example, RHEOVIBRON MODEL RHEO 2000, 3000 (trade name, manufactured by Orientec Co., LTD.).

The cured electrodeposition coating film of the present invention has a crosslink density of 1.2×10⁻³ to 2.0×10⁻³ mole/cc. When the crosslink density is lower than 1.2×10⁻³ mole/cc, blocking ability for permeation of oxygen, water or ion components may be deteriorated and corrosion property may be poor, and solvent resistance may be deteriorated because of lack of the crosslink density. When the crosslink density is greater than 2.0×10⁻³ mole/cc, elastic modulus of the cured electrodeposition coating film may be lowered and impact resistance of the resultant multilayered coating film may be deteriorated. Examples for controlling the range of the crosslink density of the cured electrodeposition coating film include, for example, using the cationic epoxy resin (A), the cationic acrylic resin (B) and the blocked isocyanate curing agent (C) in the amounts of the above-mentioned weight ratio according to the present invention.

The crosslink density of the cured electrodeposition coating film can be measured by obtaining a dynamic viscoelasticity of the coating film in a manner similar to the above-mentioned dynamic glass transition temperature, and calculating the following formula by use of a storage elastic modulus E′ in rubber domain:

E′=3 nRT

wherein E′ represents a storage elastic modulus, n represents a crosslink density, R represents a gas constant, and T represents an absolute temperature.

Furthermore, the cured electrodeposition coating film according to the present invention has phenol structural part represented the formula: —C₆H₄—O— within the range of 0.12 to 0.24 mole in molar number based on a resin solid content of 100 g in the cured electrodeposition coating film. The amount of the phenol structural part may preferably be within the range of 0.19 to 0.24 mole. When the amount of the phenol structural part is lower than 0.12 mole, blocking ability for permeation of oxygen, water or ion components may be deteriorated and adhesion property of the coating film on materials of steel plate may be deteriorated, which may result in deterioration of corrosion resistance. On the other hand, when the amount of the phenol structural part is greater than 0.24 mole, degradation of the cured coating film by light illumination may be obtained and weather resistance of the cured electrodeposition coating film may be deteriorated.

Examples for controlling within the range of the amount of the phenol structural part include, for example, using a cationic epoxy resin (A) having phenol structural part within the range of 0.35 to 0.55 mole in molar number based on a resin solid content of 100 g in an amount ratio according to the present invention.

### Formation of Multi Layered Coating Film

Applying a top coating composition on the cured electrodeposition coating film, and heating and curing the resultant uncured top coating film can provide a multi layered coating film having excellent weather resistance and film appearance. Various types of the top coating composition such as solvent-type, aqueous-type and powdered-type may be used.

In the present invention, two types of the top coating compositions, i.e., a base coating composition and a clear top coating composition can be used as the top coating composition, which can provide higher level of film appearance. In use of the two top coating compositions, a process for forming a multi layered coating film is so-called 2 coat and 1 bake (2C1B) method and includes the following steps of:

applying a base coating composition on the cured electrodeposition coating film to form an uncured base coating film,

applying a clear top coating composition on the uncured base coating film to form an uncured clear top coating film, and

simultaneously heating and curing the uncured base coating film and the uncured clear top coating film.

Applying method of the base coating composition and the clear top coating composition includes, but not particularly limited to, a coating method using, for example, air electrostatic spray coating such as generically called “react gun”, and rotary-atomizing-type air electrostatic spray coating such as generically called “micro-micro bel”, “micro bel” or “metallic-bel (meta-bel)”. An amount of the coating compositions can vary depending on their types and/or intended purposes.

After applying the base coating composition or the clear top coating composition, a time interval (so-called “Interval”) may be set. The time interval can adequately volatilize solvents contained in resultant uncured coating film, which can improve film appearance of a multi layered coating film. The time interval may be, for example, from 10 seconds to 15 minutes.

In the time interval, preheating may be preferably carried out. The preheating can effectively volatilize solvents contained in the coating film in a short time. The preheating corresponds to drying process and does not include vigorous curing process. Thus the preheating can be carried out at a temperature of room temperature to 100° C. for 1 minute to 10 minutes. The preheating may be carried out using e.g., a hot-air heater or an infrared ray heater.

Curing and heating process of the base coating composition and the clear top coating composition can be carried out using an ordinary heating furnace such as a gas furnace, an electric furnace, an infrared furnace and an induction heating furnace. Heating and curing temperature can vary depending on their types, and may be, for example, from 120 to 160° C. Heating and curing time may be, for example, from 10 to 30 minutes.

### EXAMPLES

The present invention will be further explained in detail in accordance with the following examples, but it is not construed as limiting the present invention to these examples. In the examples, “part” and “%” are based on weight unless otherwise specified.

### Productive Example 1-1

### Production of Cationic Epoxy Resin (A-1)

A flask equipped with a stirrer, a condenser, a nitrogen-gas inlet and a dropping funnel was charged with 680.9 parts of bisphenol A type epoxy resin having epoxy equivalent of 188 (available from Dow Chemical Co., trade name: DER-331J), 268.9 parts of bisphenol A, 50.4 parts of 2-ethylhexanoate, 128.9 parts of methyl isobutyl ketone (MIBK) and 0.10 part of dibutyltin dilaurate, and mixed uniformly to dissolve. The mixture was heated in the range of 130 to 142° C. until its epoxy equivalent reached to 1150.

Then, the reaction mixture was cooled to 100° C. To the content, 51.5 parts of N-methylethanolamine and 54.0 parts of diethylenetriamine diketimine (methyl isobutyl ketone solution having a solid content of 73 weight %) were added and heated to 110° C. for two hours to obtain a cationic epoxy resin (A-1). To the content, 66.25 parts of methyl isobutyl ketone was added and diluted by nonvolatile content of 85%.

The obtained cationic epoxy resin (A-1) had a number average molecular weight of 2,500, a solubility parameter (SP-value) of 11.5, a glass transition temperature of 50° C. An amount of phenol structural part represented with the formula: —C₆H₄—O— in molar number based on a resin solid content of 100 g in the cationic epoxy resin (A-1) was 0.55 mole.

### Productive Example 1-2

### Production of Cationic Epoxy Resin (A-2)

A flask equipped with a stirrer, a condenser, a nitrogen-gas inlet and a dropping funnel was charged with 680.9 parts of bisphenol A type epoxy resin having epoxy equivalent of 188 (available from Dow Chemical Co., trade name: DER-331J), 200.6 parts of bisphenol A, 146.0 parts of dimer acid (available from Tsuno CO., LTD, trade name: Tsunodaime 216), 43.2 parts of 2-ethylhexanoate, 143.9 parts of methyl isobutyl ketone and 0.10 part of dibutyltin dilaurate, and mixed uniformly to dissolve. The mixture was heated at temperature in the range of 130 to 142° C. until its epoxy equivalent reached to 1150.

Then, the reaction mixture was cooled to 100° C. To the content, 66.1 parts of N-methylethanolamine and 54.0 parts of diethylenetriamine diketimine (methyl isobutyl ketone solution having a solid content of 73 weight %) were added and heated to 110° C. for two hours to obtain a cationic epoxy resin (A-2). To the content, 66.25 parts of methyl isobutyl ketone was added and diluted by nonvolatile content of 85%.

The obtained cationic epoxy resin (A-2) had a number average molecular weight of 2,500, a solubility parameter (SP-value) of 11.5, a glass transition temperature of 40° C.

An amount of phenol structural part represented with the formula: —C₆H₄—O— in molar number based on a resin solid content of 100 g in the cationic epoxy resin (A-2) was 0.46 mole.

### Productive Example 1-3

### Production of Cationic Epoxy Resin (A-3)

A flask equipped with a stirrer, a condenser, a nitrogen-gas inlet and a dropping funnel was charged with 449.4 parts of bisphenol A type epoxy resin having epoxy equivalent of 188 (available from Dow Chemical Co., trade name: DER-331J), 252.5 parts of hydrogenated bisphenol A type epoxy resin (trade name: ST-3000, available from Tohto Kasei Co., Ltd., having epoxy equivalent of 205), 268.9 parts of bisphenol A, 50.4 parts of 2-ethylhexanoate, 133.2 parts of methyl isobutyl ketone and 0.10 part of dibutyltin dilaurate, and mixed uniformly to dissolve. The mixture was heated at temperature in the range of 130 to 142° C. until its epoxy equivalent reached to 1150.

Then, the reaction mixture was cooled to 100° C. To the content, 55.2 parts of N-methylethanolamine and 54.0 parts of diethylenetriamine diketimine (methyl isobutyl ketone solution having a solid content of 73 weight %) were added and heated to 110° C. for two hours to obtain a cationic epoxy resin (A-3). To the content, 66.25 parts of methyl isobutyl ketone was added and diluted by nonvolatile content of 85%.

The obtained cationic epoxy resin (A-3) had a number average molecular weight of 3,000, a solubility parameter (SP-value) of 11.5, a glass transition temperature of 36° C. An amount of phenol structural part represented with the formula: —C₆H₄—O— in molar number based on a resin solid content of 100 g in the cationic epoxy resin (A-3) was 0.43 mole.

### Productive Example 1-4

### Production of Cationic Epoxy Resin (A-4)

A flask equipped with a stirrer, a condenser, a nitrogen-gas inlet and a dropping funnel was charged with 425.6 parts of bisphenol A type epoxy resin having epoxy equivalent of 188 (available from Dow Chemical Co., trade name: DER-331J), 278.4 parts of hydrogenated bisphenol A type epoxy resin (trade name: ST-3000, available from Tohto Kasei Co., Ltd., having epoxy equivalent of 205), 268.9 parts of bisphenol A, 50.4 parts of 2-ethylhexanoate, 133.6 parts of methyl isobutyl ketone and 0.10 part of dibutyltin dilaurate, and mixed uniformly to dissolve. The mixture was heated at temperature in the range of 130 to 142° C. until its epoxy equivalent reached to 1150.

Then, the reaction mixture was cooled to 100° C. To the content, 55.2 parts of N-methylethanolamine and 54.0 parts of diethylenetriamine diketimine (methyl isobutyl ketone solution having a solid content of 73 weight %) were added and heated to 110° C. for two hours to obtain a cationic epoxy resin (A-4). To the content, 66.25 parts of methyl isobutyl ketone was added and diluted by nonvolatile content of 85%.

The obtained cationic epoxy resin (A-4) had a number average molecular weight of 2,500, a solubility parameter (SP-value) of 11.5, a glass transition temperature of 35° C. An amount of phenol structural part represented with the formula: —C₆H₄—O— in molar number based on a resin solid content of 100 g in the cationic epoxy resin (A-4) was 0.41 mole.

### Productive Example 1-5

### Production of Cationic Epoxy Resin (A-5)

A flask equipped with a stirrer, a condenser, a nitrogen-gas inlet and a dropping funnel was charged with 340.5 parts of bisphenol A type epoxy resin having epoxy equivalent of 188 (available from Dow Chemical Co., trade name: DER-331J), 371.3 parts of hydrogenated bisphenol A type epoxy resin (trade name: ST-3000, available from Tohto Kasei Co., Ltd., having epoxy equivalent of 205), 268.9 parts of bisphenol A, 50.4 parts of 2-ethylhexanoate, 135.0 parts of methyl isobutyl ketone and 0.10 part of dibutyltin dilaurate, and mixed uniformly to dissolve. The mixture was heated at temperature in the range of 130 to 142° C. until its epoxy equivalent reached to 1150.

Then, the reaction mixture was cooled to 100° C. To the content, 55.2 parts of N-methylethanolamine and 54.0 parts of diethylenetriamine diketimine (methyl isobutyl ketone solution having a solid content of 73 weight %) were added and heated to 110° C. for two hours to obtain a cationic epoxy resin (A-5). To the content, 66.25 parts of methyl isobutyl ketone was added and diluted by nonvolatile content of 85%.

The obtained cationic epoxy resin (A-5) had a number average molecular weight of 2,500, a solubility parameter (SP-value) of 11.5, a glass transition temperature of 30° C. An amount of phenol structural part represented with the formula: —C₆H₄—O— in molar number based on a resin solid content of 100 g in the cationic epoxy resin (A-5) was 0.37 mole.

The cationic epoxy resin (A-1) to (A-5) obtained the above productive examples are shown in the Table 1.

TABLE 1

| Productive Example No. | 1-1 | 1-2 | 1-3 | 1-4 | 1-5 |
|---|---|---|---|---|---|
| cationic epoxy resin | A-1 | A-2 | A-3 | A-4 | A-5 |
| bisphenol A type epoxy resin | 680.9 | 680.9 | 449.4 | 425.6 | 340.5 |
| (Trade name: DER-331J) | | | | | |
| hydrogenated bisphenol A type epoxy resin | — | — | 252.5 | 278.4 | 371.3 |
| (trade name: ST-3000), available from | | | | | |
| Tohto Kasei, epoxy equivalent of 205 | | | | | |
| bisphenol A | 268.9 | 200.6 | 268.9 | 268.9 | 268.9 |
| dimer acid (trade name: Tsunodaime 216) | — | 146.0 | — | — | — |
| 2-ethylhexanoate | 50.4 | 43.2 | 50.4 | 50.4 | 50.4 |
| diethylenetriamine diketimine | 54.0 | 54.0 | 54.0 | 54.0 | 54.0 |
| (MIBK solution of 73 wt %) | | | | | |
| N-methylethanolamine | 51.5 | 66.1 | 55.2 | 55.2 | 55.2 |
| amount of phenol structural part based | 0.55 | 0.46 | 0.43 | 0.41 | 0.37 |
| on a resin solid content of 100 g | | | | | |
| number average molecular weight | 2500 | 2500 | 3000 | 2500 | 2500 |
| solubility parameter (SP-value) | 11.5 | 11.5 | 11.5 | 11.5 | 11.5 |
| Tg (° C.) | 50 | 40 | 36 | 35 | 30 |

### Productive Example 2-1

### Production of Cationic Acrylic Resin (B-1)

A five-necked flask equipped with a reflux condenser, a stirrer, a dropping funnel and a nitrogen-gas inlet was charged with 59.6 parts of methyl isobutyl ketone kept at 115° C. with heating under nitrogen atmosphere. A mixture of 16.0 parts of glycidyl methacrylate, 39.4 parts of hydroxyethyl methacrylate, 14.0 parts of methyl methacrylate, 16.2 parts of isobornyl methacrylate, 14.4 parts of n-butyl acrylate and 5.0 parts of t-butyl peroxy 2-ethylhexanoate was added thereto dropwise over 3 hours with the dropping funnel. The reacting mixture was kept at 115° C. for one hour after drop, then 1.0 parts of t-butyl peroxy 2-ethylhexanoate was added dropwise and kept at 115° C. for 0.5 hours to obtain a cationic acrylic resin solution having solid content of 64 wt %. Then, the obtaining solution was concentrate under reduced pressure until the solution reached nonvolatile content of 75%. After cooling, 8.5 parts of N-methyl ethanolamine was added thereto and mixed at 120° C. for 2 hours under nitrogen atmosphere to obtain a solution of a cationic acrylic resin (B-1) having a solid content of about 76%.

The obtained cationic acrylic resin (B-1) had a number average molecular weight (Mn) of 5,500, a solubility parameter (SP-value) of 11.3, and a glass transition temperature of 50° C.

### Productive Examples 2-2 to 2-6

### Productions of Cationic Acrylic Resins (B-2) to (B-6)

Cationic acrylic resins (B-2) to (B-6) were prepared in the same manner as productive example 2-1, except that amounts and kind of monomers were changed as shown in Table 2. A number average molecular weight (Mn), a solubility parameter (SP-value) and a glass transition temperature of the obtaining cationic acrylic resins (B-2) to (B-6) are shown in Table 2.

TABLE 2

| | | | Productive Example No. | | | | | |
|---|---|---|---|---|---|---|---|---|
| | | | 2-1 | 2-2 | 2-3 | 2-4 | 2-5 | 2-6 |
| cationic acrylic resin | | | B-1 | B-2 | B-3 | B-4 | B-5 | B-6 |
| wt. of | glycidyl methacrylate | | 16.0 | 16.0 | 16.0 | 16.0 | 16.0 | 16.0 |
| monomer | hydroxyethyl methacrylate | | 39.4 | 39.4 | 39.4 | 39.4 | 39.4 | 39.4 |
| | methyl methacrylate | | 14.0 | 11.5 | 8.9 | 11.5 | 16.3 | — |
| | isobornyl methacrylate | | 16.2 | 14.0 | 11.7 | 14.0 | 18.3 | 22.2 |
| | n-butyl acrylate | | 14.4 | 19.0 | 24.0 | 19.0 | 10.0 | 18.6 |
| | ethylhexyl methacrylate | | — | — | — | — | — | 3.8 |
| initiator | t-butyl peroxy 2- | 1st stage | 5.0 | 5.0 | 5.0 | 3.0 | 5.0 | 5.0 |
| | ethylhexanoate | 2nd stage | 1.0 | 1.0 | 1.0 | 1.0 | 1.0 | 1.0 |

| | | | | | | | |
|---|---|---|---|---|---|---|---|
| amine | N-methyl ethanolamine | 8.5 | 8.5 | 8.5 | 8.5 | 8.5 | 8.5 |

| | | | | | | |
|---|---|---|---|---|---|---|
| number average molecular weight | 5500 | 5500 | 5500 | 7000 | 5500 | 5500 |
| solubility parameter (SP-value) | 11.3 | 11.3 | 11.3 | 11.3 | 11.3 | 11.0 |
| Tg (° C.) | 50 | 40 | 30 | 40 | 60 | 40 |

### Productive Example 3

### Production of Blocked Isocyanate Curing Agent (C)

A reaction vessel equipped with a stirrer, a nitrogen-gas inlet, a condenser and a thermometer was charged with 222 parts of isophorone diisocyanate and diluted with 56 parts of methyl isobutyl ketone. Then, 0.2 parts of dibutyltin dilaurate was added thereto and heated to 50° C., to which 17 parts of methyl ethyl ketoxime was added while keeping a temperature of the content not more than 70° C. The reaction mixture was then kept at 70° C. for one hour until an absorption of isocyanate moiety in infrared absorption spectrum substantially disappeared. It was diluted with 43 parts of n-butanol to obtain a blocked isocyanate curing agent (C) having a solid content of 70% by weight. The blocked isocyanate curing agent (C) had a solubility parameter (SP-value) of 11.8.

### Productive Example 4

### Production of Pigment Dispersing Resin

A reaction vessel equipped with a stirrer, a condenser, a nitrogen-gas inlet and a thermometer was charged with 710 parts of bisphenol A type epoxy resin having an epoxy equivalent of 198 (available from Shell Chemical Co., trade name: Epon 829) and 289.6 parts of bisphenol A, and reacted at temperature of 150 to 160° C. for one hour under nitrogen atmosphere. After cooling to 120° C., 406.4 parts of a methyl isobutyl ketone solution containing tolylene diisocyanate half-blocked with 2-ethylhexanol (solid content of 95 wt %) was added to react. The reaction mixture was kept for one hour at temperature of 110 to 120° C., to which 1584.1 parts of ethyleneglycol n-monobutyl ether was added, followed by cooling to 85 to 95° C., and mixing uniformly to obtain reacted material.

Separately, another reaction vessel was charged with 384 parts of a methyl isobutyl ketone solution containing tolylene diisocyanate half-blocked with 2-ethylhexanol (solid content of 95 wt %) and 104.6 parts of dimethylethanolamine, and mixed for one hour at 80° C. Then 141.1 parts of a 75% lactic acid solution and 47.0 parts of ethyleneglycol n-butyl ether were added thereto, and mixed for 30 minutes to obtain a quaternerizing agent having a solid content of 85 wt %. Thereafter, 620.5 parts of the quaternerizing agent was added to the above obtained reacted material and kept at temperature of 85 to 95° C. to achieve acid value of 1, thus obtaining a resin solution of pigment dispersing resin having solid content of 56 wt %, a number average molecular weight of 2,200 and solubility parameter be of 11.3.

### Productive Example 5

### Production of Pigment Dispersing Paste

In a sand mill, 198.5 parts of pigment dispersing resin prepared by productive example 4, 2.0 parts of carbon black, 100.0 parts of kaolin, 80.0 parts of titanium dioxide, 18.0 parts of aluminum phosphomolybdate, 15.0 parts of silicon dioxide (porous silica particle, trade name “Sylysia 530”, available by Fuji Silysia Chemical Inc.), 32.0 parts of dibutyltin oxide and 217.7 parts of ion-exchanged water were dispersed until its grain size became under 10 μm, to obtain a pigment dispersing paste having a solid content of 54 wt %. An equilibrium concentration of silicate ion eluted from the silicon dioxide in a condition that the silicon dioxide was soaked in an aqueous alkaline solution of pH 12 at 50° C. for 3 days was 85 ppm.

### Productive Example 6-1

### Production of Cationic Epoxy Resin Emulsion (a-1)

Into the solution of cationic epoxy resin (A-1) obtained in productive example 1-1 (82.5 parts), 37.5 parts of blocked isocyanate curing agent (C) obtained in Productive Example 3 was added and stirred for 30 minutes. Then, 2.0 parts of acetic acid was added, and ion-exchanged water was added thereto such that a non-volatile content of the mixture was 30 wt %, and condensed under reduced pressure up to non-volatile content of 36 wt %, to obtain cationic epoxy resin emulsion (a-1).

### Productive Example 6-2

### Production of Cationic Epoxy Resin Emulsion (a-2)

Into the solution of cationic epoxy resin (A-1) obtained in productive example 1-1 (73.0 parts), 47.5 parts of blocked isocyanate curing agent (C) obtained in Productive Example 3 was added and stirred for 30 minutes. Then, 2.0 parts of acetic acid was added, and ion-exchanged water was added thereto such that a non-volatile content of the mixture was 30 wt %, and condensed under reduced pressure up to non-volatile content of 36 wt %, to obtain cationic epoxy resin emulsion (a-2).

### Productive Example 6-3

### Production of Cationic Epoxy Resin Emulsion (a-3)

Into the solution of cationic epoxy resin (A-1) obtained in productive example 1-1 (70.7 parts), 50.0 parts of blocked isocyanate curing agent (C) obtained in Productive Example 3 was added and stirred for 30 minutes. Then, 2.0 parts of acetic acid was added, and ion-exchanged water was added thereto such that a non-volatile content of the mixture was 30 wt %, and condensed under reduced pressure up to non-volatile content of 36 wt %, to obtain cationic epoxy resin emulsion (a-3).

### Productive Example 6-4

### Production of Cationic Epoxy Resin Emulsion (a-4)

Into the solution of cationic epoxy resin (A-2) obtained in productive example 1-2 (82.5 parts), 37.5 parts of blocked isocyanate curing agent (C) obtained in Productive Example 3 was added and stirred for 30 minutes. Then, 2.0 parts of acetic acid was added, and ion-exchanged water was added thereto such that a non-volatile content of the mixture was 30 wt %, and condensed under reduced pressure up to non-volatile content of 36 wt %, to obtain cationic epoxy resin emulsion (a-4).

### Productive Example 6-5

### Production of Cationic Epoxy Resin Emulsion (a-5)

Into the solution of cationic epoxy resin (A-2) obtained in productive example 1-2 (109.5 parts), 8.75 parts of blocked isocyanate curing agent (C) obtained in Productive Example 3 was added and stirred for 30 minutes. Then, 2.0 parts of acetic acid was added, and ion-exchanged water was added thereto such that a non-volatile content of the mixture was 30 wt %, and condensed under reduced pressure up to non-volatile content of 36 wt %, to obtain cationic epoxy resin emulsion (a-5).

### Productive Example 6-6

### Production of Cationic Epoxy Resin Emulsion (a-6)

Into the solution of cationic epoxy resin (A-3) obtained in productive example 1-3 (82.5 parts), 37.5 parts of blocked isocyanate curing agent (C) obtained in Productive Example 3 was added and stirred for 30 minutes. Then, 2.0 parts of acetic acid was added, and ion-exchanged water was added thereto such that a non-volatile content of the mixture was 30 wt %, and condensed under reduced pressure up to non-volatile content of 36 wt %, to obtain cationic epoxy resin emulsion (a-6).

### Productive Example 6-7

### Production of Cationic Epoxy Resin Emulsion (a-7)

Into the solution of cationic epoxy resin (A-4) obtained in productive example 1-4 (82.5 parts), 37.5 parts of blocked isocyanate curing agent (C) obtained in Productive Example 3 was added and stirred for 30 minutes. Then, 2.0 parts of acetic acid was added, and ion-exchanged water was added thereto such that a non-volatile content of the mixture was 30 wt %, and condensed under reduced pressure up to non-volatile content of 36 wt %, to obtain cationic epoxy resin emulsion (a-7).

### Productive Example 6-8

### Production of Cationic Epoxy Resin Emulsion (a-8)

Into the solution of cationic epoxy resin (A-5) obtained in productive example 1-5 (82.5 parts), 37.5 parts of blocked isocyanate curing agent (C) obtained in Productive Example 3 was added and stirred for 30 minutes. Then, 2.0 parts of acetic acid was added, and ion-exchanged water was added thereto such that a non-volatile content of the mixture was 30 wt %, and condensed under reduced pressure up to non-volatile content of 36 wt %, to obtain cationic epoxy resin emulsion (a-8).

The cationic epoxy resin emulsions (a-1) to (a-8) obtained the above productive examples 6-1 to 6-8 are shown in the Table 3.

TABLE 3

| | | Productive Example No. | | | | | | | |
|---|---|---|---|---|---|---|---|---|---|
| | | 6-1 | 6-2 | 6-3 | 6-4 | 6-5 | 6-6 | 6-7 | 6-8 |
| cationic epoxy resin | | a-1 | a-2 | a-3 | a-4 | a-5 | a-6 | a-7 | a-8 |
| emulsion | | | | | | | | | |
| cationic epoxy resin | A-1 | 82.5 | 73.0 | 70.7 | | | | | |
| | A-2 | | | | 82.5 | 109.5 | | | |
| | A-3 | | | | | | 82.5 | | |
| | A-4 | | | | | | | 82.5 | |
| | A-5 | | | | | | | | 82.5 |

| | | | | | | | | |
|---|---|---|---|---|---|---|---|---|
| blocked isocyanate | 37.5 | 47.5 | 50 | 37.5 | 8.75 | 37.5 | 37.5 | 37.5 |
| curing agent | | | | | | | | |

### Productive Example 7-1

### Production of Cationic Acrylic Resin Emulsion (b-1)

Into the solution of cationic acrylic resin (B-1) obtained in productive example 2-1 (92.1 parts), 37.5 parts of blocked isocyanate curing agent (C) obtained in Productive Example 3 was added and stirred for 30 minutes. Then, 2.0 parts of acetic acid was added, and ion-exchanged water was added thereto such that a non-volatile content of the mixture was 24 wt %, and condensed under reduced pressure up to non-volatile content of 30 wt %, to obtain cationic acrylic resin emulsion (b-1).

### Productive Example 7-2

### Production of Cationic Acrylic Resin Emulsion (b-2)

Into the solution of cationic acrylic resin (B-2) obtained in productive example 2-2 (92.1 parts), 37.5 parts of blocked isocyanate curing agent (C) obtained in Productive Example 3 was added and stirred for 30 minutes. Then, 2.0 parts of acetic acid was added, and ion-exchanged water was added thereto such that a non-volatile content of the mixture was 24 wt %, and condensed under reduced pressure up to non-volatile content of 30 wt %, to obtain cationic acrylic resin emulsion (b-2).

### Productive Example 7-3

### Production of Cationic Acrylic Resin Emulsion (b-3)

Into the solution of cationic acrylic resin (B-3) obtained in productive example 2-3 (92.1 parts), 37.5 parts of blocked isocyanate curing agent (C) obtained in Productive Example 3 was added and stirred for 30 minutes. Then, 2.0 parts of acetic acid was added, and ion-exchanged water was added thereto such that a non-volatile content of the mixture was 24 wt %, and condensed under reduced pressure up to non-volatile content of 30 wt %, to obtain cationic acrylic resin emulsion (b-3).

### Productive Example 7-4

### Production of Cationic Acrylic Resin Emulsion (b-4)

Into the solution of cationic acrylic resin (B-4) obtained in productive example 2-4 (92.1 parts), 37.5 parts of blocked isocyanate curing agent (C) obtained in Productive Example 3 was added and stirred for 30 minutes. Then, 2.0 parts of acetic acid was added, and ion-exchanged water was added thereto such that a non-volatile content of the mixture was 24 wt %, and condensed under reduced pressure up to non-volatile content of 30 wt %, to obtain cationic acrylic resin emulsion (b-4).

### Productive Example 7-5

### Production of Cationic Acrylic Resin Emulsion (b-5)

Into the solution of cationic acrylic resin (B-5) obtained in productive example 2-5 (92.1 parts), 37.5 parts of blocked isocyanate curing agent (C) obtained in Productive Example 3 was added and stirred for 30 minutes. Then, 2.0 parts of acetic acid was added, and ion-exchanged water was added thereto such that a non-volatile content of the mixture was 24 wt %, and condensed under reduced pressure up to non-volatile content of 30 wt %, to obtain cationic acrylic resin emulsion (b-5).

### Productive Example 7-6

### Production of Cationic Acrylic Resin Emulsion (b-6)

Into the solution of cationic acrylic resin (B-6) obtained in productive example 2-6 (92.1 parts), 37.5 parts of blocked isocyanate curing agent (C) obtained in Productive Example 3 was added and stirred for 30 minutes. Then, 2.0 parts of acetic acid was added, and ion-exchanged water was added thereto such that a non-volatile content of the mixture was 24 wt %, and condensed under reduced pressure up to non-volatile content of 30 wt %, to obtain cationic acrylic resin emulsion (b-6).

The cationic acrylic resin emulsions (b-1) to (b-6) obtained the above productive examples 7-1 to 7-6 are shown in the Table 4.

TABLE 4

| | | Productive Example No. | | | | | |
|---|---|---|---|---|---|---|---|
| | | 7-1 | 7-2 | 7-3 | 7-4 | 7-5 | 7-6 |
| cationic acrylic resin | | b-1 | b-2 | b-3 | b-4 | b-5 | b-6 |
| emulsion | | | | | | | |
| cationic | B-1 | 92.1 | | | | | |
| acrylic resin | B-2 | | 92.1 | | | | |
| emulsion | B-3 | | | 92.1 | | | |
| | B-4 | | | | 92.1 | | |
| | B-5 | | | | | 92.1 | |
| | B-6 | | | | | | 92.1 |

| | | | | | | |
|---|---|---|---|---|---|---|
| blocked isocyanate | 37.5 | 37.5 | 37.5 | 37.5 | 37.5 | 37.5 |
| curing agent | | | | | | |

### Example 1

Production of a Cationic Electrodeposition Coating Composition

The cationic epoxy resin emulsion (a-1) obtained in productive example 6-1 (167 parts), 265 parts of the cationic acrylic resin emulsion (b-2) obtained in productive example 7-2, 112 parts of the pigment dispersing paste obtained in productive example 5 and 456 parts of ion exchanged water were mixed to obtain a cationic electrodeposition coating composition. A solid content of the cationic electrodeposition coating composition was 20%.

Production of a Cured Electrodeposition Coating Film

Electrodeposition coating was conducted using the obtained cationic electrodeposition coating composition on steel plate (SPCC-SD, JIS G3134) treated with zinc phosphate (Surfdine SD-5000, available from Nippon Paint Co., Ltd.) at a bath temperature of 28° C. and an applied voltage of 200 V and for 180 seconds. Then the steel plate was washed with water, and baked for at 160° C. for 25 minutes, and cooled in the air, to obtain a cured electrodeposition coating film having a film thickness of 15 μm.

The obtained cured electrodeposition coating film had a dynamic glass transition temperature of 116° C. and a crosslink density of 1.2×10⁻³ mole/cc. The dynamic glass transition temperature and crosslink density were measured by RHEOVIBRON MODEL RHEO 2000 (trade name, manufactured by Orientec Co., LTD.).

An amount of phenol structural part represented with the formula: —C₆H₄—O— in molar number based on a resin solid content of 100 g in the cured electrodeposition coating film was 0.174 mol, measured by calculation.

### Example 2

The cationic epoxy resin emulsion (a-7) obtained in productive example 6-7 (167 parts), 265 parts of the cationic acrylic resin emulsion (b-1) obtained in productive example 7-1, 112 parts of the pigment dispersing paste obtained in productive example 5 and 456 parts of ion exchanged water were mixed to obtain a cationic electrodeposition coating composition. A solid content of the cationic electrodeposition coating composition was 20%.

Electrodeposition coating was conducted in the same manner as example 1 to obtain a cured electrodeposition coating film.

The obtained cured electrodeposition coating film had a dynamic glass transition temperature of 114° C. and a crosslink density of 1.2×10⁻³ mole/cc.

An amount of phenol structural part represented with the formula: —C₆H₄—O— in molar number based on a resin solid content of 100 g in the cured electrodeposition coating film was 0.139 mol, measured by calculation.

### Example 3

The cationic epoxy resin emulsion (a-8) obtained in productive example 6-8 (167 parts), 265 parts of the cationic acrylic resin emulsion (b-1) obtained in productive example 7-1, 112 parts of the pigment dispersing paste obtained in productive example 5 and 456 parts of ion exchanged water were mixed to obtain a cationic electrodeposition coating composition. A solid content of the cationic electrodeposition coating composition was 20%.

Electrodeposition coating was conducted in the same manner as example 1 to obtain a cured electrodeposition coating film.

The obtained cured electrodeposition coating film had a dynamic glass transition temperature of 108° C. and a crosslink density of 1.2×10⁻³ mole/cc.

An amount of phenol structural part represented with the formula: —C₆H₄—O— in molar number based on a resin solid content of 100 g in the cured electrodeposition coating film was 0.128 mol, measured by calculation.

### Example 4

The cationic epoxy resin emulsion (a-4) obtained in productive example 6-4 (279 parts), 130 parts of the cationic acrylic resin emulsion (b-1) obtained in productive example 7-1, 112 parts of the pigment dispersing paste obtained in productive example 5 and 479 parts of ion exchanged water were mixed to obtain a cationic electrodeposition coating composition. A solid content of the cationic electrodeposition coating composition was 20%.

Electrodeposition coating was conducted in the same manner as example 1 to obtain a cured electrodeposition coating film.

The obtained cured electrodeposition coating film had a dynamic glass transition temperature of 108° C. and a crosslink density of 1.2×10⁻³ mole/cc.

An amount of phenol structural part represented with the formula: —C₆H₄—O— in molar number based on a resin solid content of 100 g in the cured electrodeposition coating film was 0.232 mol, measured by calculation.

### Example 5

The cationic epoxy resin emulsion (a-4) obtained in productive example 6-4 (221 parts), 200 parts of the cationic acrylic resin emulsion (b-1) obtained in productive example 7-1, 112 parts of the pigment dispersing paste obtained in productive example 5 and 467 parts of ion exchanged water were mixed to obtain a cationic electrodeposition coating composition. A solid content of the cationic electrodeposition coating composition was 20%.

Electrodeposition coating was conducted in the same manner as example 1 to obtain a cured electrodeposition coating film.

The obtained cured electrodeposition coating film had a dynamic glass transition temperature of 116° C. and a crosslink density of 1.2×10⁻³ mole/cc.

An amount of phenol structural part represented with the formula: —C₆H₄—O— in molar number based on a resin solid content of 100 g in the cured electrodeposition coating film was 0.190 mol, measured by calculation.

### Example 6

The cationic epoxy resin emulsion (a-7) obtained in productive example 6-7 (221 parts), 200 parts of the cationic acrylic resin emulsion (b-1) obtained in productive example 7-1, 112 parts of the pigment dispersing paste obtained in productive example 5 and 467 parts of ion exchanged water were mixed to obtain a cationic electrodeposition coating composition. A solid content of the cationic electrodeposition coating composition was 20%.

Electrodeposition coating was conducted in the same manner as example 1 to obtain a cured electrodeposition coating film.

The obtained cured electrodeposition coating film had a dynamic glass transition temperature of 108° C. and a crosslink density of 1.2×10⁻³ mole/cc.

An amount of phenol structural part represented with the formula: —C₆H₄—O— in molar number based on a resin solid content of 100 g in the cured electrodeposition coating film was 0.175 mol, measured by calculation.

### Example 7

The cationic epoxy resin emulsion (a-6) obtained in productive example 6-6 (279 parts), 130 parts of the cationic acrylic resin emulsion (b-1) obtained in productive example 7-1, 112 parts of the pigment dispersing paste obtained in productive example 5 and 479 parts of ion exchanged water were mixed to obtain a cationic electrodeposition coating composition. A solid content of the cationic electrodeposition coating composition was 20%.

Electrodeposition coating was conducted in the same manner as example 1 to obtain a cured electrodeposition coating film.

The obtained cured electrodeposition coating film had a dynamic glass transition temperature of 105° C. and a crosslink density of 1.2×10⁻³ mole/cc.

An amount of phenol structural part represented with the formula: —C₆H₄—O— in molar number based on a resin solid content of 100 g in the cured electrodeposition coating film was 0.219 mol, measured by calculation.

### Example 8

The cationic epoxy resin emulsion (a-7) obtained in productive example 6-7 (248 parts), 168 parts of the cationic acrylic resin emulsion (b-1) obtained in productive example 7-1, 112 parts of the pigment dispersing paste obtained in productive example 5 and 472 parts of ion exchanged water were mixed to obtain a cationic electrodeposition coating composition. A solid content of the cationic electrodeposition coating composition was 20%.

Electrodeposition coating was conducted in the same manner as example 1 to obtain a cured electrodeposition coating film.

The obtained cured electrodeposition coating film had a dynamic glass transition temperature of 110° C. and a crosslink density of 1.2×10⁻³ mole/cc.

An amount of phenol structural part represented with the formula: —C₆H₄—O— in molar number based on a resin solid content of 100 g in the cured electrodeposition coating film was 0.192 mol, measured by calculation.

### Example 9

The cationic epoxy resin emulsion (a-3) obtained in productive example 6-3 (194 parts), 233 parts of the cationic acrylic resin emulsion (b-1) obtained in productive example 7-1, 112 parts of the pigment dispersing paste obtained in productive example 5 and 462 parts of ion exchanged water were mixed to obtain a cationic electrodeposition coating composition. A solid content of the cationic electrodeposition coating composition was 20%.

Electrodeposition coating was conducted in the same manner as example 1 to obtain a cured electrodeposition coating film.

The obtained cured electrodeposition coating film had a dynamic glass transition temperature of 120° C. and a crosslink density of 1.5×10⁻³ mole/cc.

An amount of phenol structural part represented with the formula: —C₆H₄—O— in molar number based on a resin solid content of 100 g in the cured electrodeposition coating film was 0.174 mol, measured by calculation.

### Comparative Example 1

The cationic epoxy resin emulsion (a-1) obtained in productive example 6-1 (112 parts), 330 parts of the cationic acrylic resin emulsion (b-2) obtained in productive example 7-2, 112 parts of the pigment dispersing paste obtained in productive example 5 and 445 parts of ion exchanged water were mixed to obtain a cationic electrodeposition coating composition. A solid content of the cationic electrodeposition coating composition was 20%.

Electrodeposition coating was conducted in the same manner as example 1 to obtain a cured electrodeposition coating film.

The obtained cured electrodeposition coating film had a dynamic glass transition temperature of 112° C. and a crosslink density of 1.5×10⁻³ mole/cc.

An amount of phenol structural part represented with the formula: —C₆H₄—O— in molar number based on a resin solid content of 100 g in the cured electrodeposition coating film was 0.126 mol, measured by calculation.

### Comparative Example 2

The cationic epoxy resin emulsion (a-5) obtained in productive example 6-5 (167 parts), 265 parts of the cationic acrylic resin emulsion (b-3) obtained in productive example 7-3, 112 parts of the pigment dispersing paste obtained in productive example 5 and 456 parts of ion exchanged water were mixed to obtain a cationic electrodeposition coating composition. A solid content of the cationic electrodeposition coating composition was 20%.

Electrodeposition coating was conducted in the same manner as example 1 to obtain a cured electrodeposition coating film.

The obtained cured electrodeposition coating film had a dynamic glass transition temperature of 107° C. and a crosslink density of 0.6×10⁻³ mole/cc.

An amount of phenol structural part represented with the formula: —C₆H₄—O— in molar number based on a resin solid content of 100 g in the cured electrodeposition coating film was 0.190 mol, measured by calculation.

### Comparative Example 3

The cationic epoxy resin emulsion (a-1) obtained in productive example 6-1 (167 parts), 265 parts of the cationic acrylic resin emulsion (b-3) obtained in productive example 7-3, 112 parts of the pigment dispersing paste obtained in productive example 5 and 456 parts of ion exchanged water were mixed to obtain a cationic electrodeposition coating composition. A solid content of the cationic electrodeposition coating composition was 20%.

Electrodeposition coating was conducted in the same manner as example 1 to obtain a cured electrodeposition coating film.

The obtained cured electrodeposition coating film had a dynamic glass transition temperature of 100° C. and a crosslink density of 1.2×10⁻³ mole/cc.

An amount of phenol structural part represented with the formula: —C₆H₄—O— in molar number based on a resin solid content of 100 g in the cured electrodeposition coating film was 0.174 mol, measured by calculation.

### Comparative Example 4

The cationic epoxy resin emulsion (a-1) obtained in productive example 6-1 (279 parts), 130 parts of the cationic acrylic resin emulsion (b-3) obtained in productive example 7-3, 112 parts of the pigment dispersing paste obtained in productive example 5 and 479 parts of ion exchanged water were mixed to obtain a cationic electrodeposition coating composition. A solid content of the cationic electrodeposition coating composition was 20%.

Electrodeposition coating was conducted in the same manner as example 1 to obtain a cured electrodeposition coating film.

The obtained cured electrodeposition coating film had a dynamic glass transition temperature of 116° C. and a crosslink density of 1.2×10⁻³ mole/cc.

An amount of phenol structural part represented with the formula: —C₆H₄—O— in molar number based on a resin solid content of 100 g in the cured electrodeposition coating film was 0.271 mol, measured by calculation.

### Comparative Example 5

The cationic epoxy resin emulsion (a-7) obtained in productive example 6-7 (333 parts), 65 parts of the cationic acrylic resin emulsion (b-1) obtained in productive example 7-1, 112 parts of the pigment dispersing paste obtained in productive example 5 and 490 parts of ion exchanged water were mixed to obtain a cationic electrodeposition coating composition. A solid content of the cationic electrodeposition coating composition was 20%.

Electrodeposition coating was conducted in the same manner as example 1 to obtain a cured electrodeposition coating film.

The obtained cured electrodeposition coating film had a dynamic glass transition temperature of 96° C. and a crosslink density of 1.2×10³ mole/cc.

An amount of phenol structural part represented with the formula: —C₆H₄—O— in molar number based on a resin solid content of 100 g in the cured electrodeposition coating film was 0.250 mol, measured by calculation.

### Comparative Example 6

The cationic epoxy resin emulsion (a-1) obtained in productive example 6-1 (333 parts), 65 parts of the cationic acrylic resin emulsion (b-1) obtained in productive example 7-1, 112 parts of the pigment dispersing paste obtained in productive example 5 and 490 parts of ion exchanged water were mixed to obtain a cationic electrodeposition coating composition. A solid content of the cationic electrodeposition coating composition was 20%.

Electrodeposition coating was conducted in the same manner as example 1 to obtain a cured electrodeposition coating film.

The obtained cured electrodeposition coating film had a dynamic glass transition temperature of 132° C. and a crosslink density of 1.2×10⁻³ mole/cc.

An amount of phenol structural part represented with the formula: —C₆H₄—O— in molar number based on a resin solid content of 100 g in the cured electrodeposition coating film was 0.319 mol, measured by calculation.

### Comparative Example 7

The cationic epoxy resin emulsion (a-3) obtained in productive example 6-3 (194 parts), 223 parts of the cationic acrylic resin emulsion (b-3) obtained in productive example 7-3, 112 parts of the pigment dispersing paste obtained in productive example 5 and 462 parts of ion exchanged water were mixed to obtain a cationic electrodeposition coating composition. A solid content of the cationic electrodeposition coating composition was 20%.

Electrodeposition coating was conducted in the same manner as example 1 to obtain a cured electrodeposition coating film.

The obtained cured electrodeposition coating film had a dynamic glass transition temperature of 92° C. and a crosslink density of 1.5×10⁻³ mole/cc.

An amount of phenol structural part represented with the formula: —C₆H₄—O— in molar number based on a resin solid content of 100 g in the cured electrodeposition coating film was 0.174 mol, measured by calculation.

### Comparative Example 8

The cationic epoxy resin emulsion (a-1) obtained in productive example 6-1 (167 parts), 265 parts of the cationic acrylic resin emulsion (b-4) obtained in productive example 7-4, 112 parts of the pigment dispersing paste obtained in productive example 5 and 456 parts of ion exchanged water were mixed to obtain a cationic electrodeposition coating composition. A solid content of the cationic electrodeposition coating composition was 20%.

Electrodeposition coating was conducted in the same manner as example 1 to obtain a cured electrodeposition coating film.

The obtained cured electrodeposition coating film had a dynamic glass transition temperature of 116° C. and a crosslink density of 1.2×10⁻³ mole/cc.

An amount of phenol structural part represented with the formula: —C₆H₄—O— in molar number based on a resin solid content of 100 g in the cured electrodeposition coating film was 0.174 mol, measured by calculation.

### Comparative Example 9

The cationic epoxy resin emulsion (a-8) obtained in productive example 6-8 (167 parts), 265 parts of the cationic acrylic resin emulsion (b-5) obtained in productive example 7-5, 112 parts of the pigment dispersing paste obtained in productive example 5 and 456 parts of ion exchanged water were mixed to obtain a cationic electrodeposition coating composition. A solid content of the cationic electrodeposition coating composition was 20%.

Electrodeposition coating was conducted in the same manner as example 1 to obtain a cured electrodeposition coating film.

The obtained cured electrodeposition coating film had a dynamic glass transition temperature of 112° C. and a crosslink density of 1.2×10⁻³ mole/cc.

An amount of phenol structural part represented with the formula: —C₆H₄—O— in molar number based on a resin solid content of 100 g in the cured electrodeposition coating film was 0.160 mol, measured by calculation.

### Comparative Example 10

The cationic epoxy resin emulsion (a-1) obtained in productive example 6-1 (167 parts), 265 parts of the cationic acrylic resin emulsion (b-6) obtained in productive example 7-6, 112 parts of the pigment dispersing paste obtained in productive example 5 and 456 parts of ion exchanged water were mixed to obtain a cationic electrodeposition coating composition. A solid content of the cationic electrodeposition coating composition was 20%.

Electrodeposition coating was conducted in the same manner as example 1 to obtain a cured electrodeposition coating film.

The obtained cured electrodeposition coating film had a dynamic glass transition temperature of 116° C. and a crosslink density of 1.2×10⁻³ mole/cc.

An amount of phenol structural part represented with the formula: —C₆H₄—O— in molar number based on a resin solid content of 100 g in the cured electrodeposition coating film was 0.174 mol, measured by calculation.

The following evaluations were performed using the cured electrodeposition coating film obtained in the above examples and comparative examples.

Evaluation of Weather Resistance

The cured electrodeposition coating films obtained in the above examples and comparative examples were placed in exposure of a Super UV accelerating test machine (Eye Super UV Tester (SUV-W151), available from IWASAKI ELECTRIC CO., LTD., irradiation condition: 100 mW of illumination intensity, 63° C. of temperature, 70% of humidity), and the exposure was stopped per 0.6 MJ/m² of irradiance level.

After the exposure, top solid coating composition (trade name: OTO 649 Cool White A2W, available from Nippon Paint Co., Ltd.) was applied by use of an air spray such that the dry film thickness of the resultant coating film was 35 μm, and heated and cured at 140° C. for 30 minutes. The obtained multi layered coating film was soaked in ion exchanged water (50° C.) for 24 hours and then adhesive property (grid of 2 mm width, evaluated by a stripping test) was performed and evaluated under the following evaluation standards. In the evaluation, multi layered coating film having stripped area of less than 15% in all grid area was determined as acceptance.

### Evaluation Standards

A: A maximum irradiance level in acceptance was greater than or equal to 15 MJ/m².
C: A maximum irradiance level in acceptance was under 15 MJ/m².

Evaluation of Corrosion Resistance (Corrosion Resistance Evaluation Under Mud Coat)

Mud containing each of 15% Na⁺, Ca²⁺, Cl⁻, SO₄²⁻ ions was applied on the cured electrodeposition coating film such that mud coat thickness was about 0.3 to 0.6 mm, and was dried. The obtained coated test plate was plated under cycle modes of salt spray (6 hours), drying time (3 hours) and wet condition (14 hours). Then the coated test plate was washed to remove the mud coat on the coated test plate, and blister area in the coated test plate was evaluated in visual contact under the following evaluation standards.

### Evaluation Standards

A: Blister area was less than 10%.
B: Blister area was equal or greater than 10% and less than 30%.
C: Blister area was equal or greater than 30%.

Evaluation of Appearance of Cured Electrodeposition Coating Film

Surface conditions of the resultant cured electrodeposition coating films were evaluated using an evaluation-type surface roughness tester (SURFTEST SJ-201P, available from Mitsutoyo Corporation), according to JIS-B0601. Surface roughness (Ra) of the electrodeposition coating films was determined in 7 times using sample having a cut-off of 2.5 mm (compartment: five), and was averaged by maximum and minimum elimination method. The Ra-value means a parameter representing surface roughness. The obtained Ra values were evaluated under the following evaluation standards.

### Evaluation Standards

A: Ra value was less than 0.25 μm.
C: Ra value was greater than or equal to 0.25 μm.

Weight rates of resin solid components of resins of components (A) to (C) film properties of the obtained cured electrodeposition coating film, and the results of the above evaluations are shown in the following tables.

TABLE 5

| | | Example 1 | Example 2 | Example 3 | Example 4 | Example 5 | Example 6 | Example 7 | Example 8 | Example 9 |
|---|---|---|---|---|---|---|---|---|---|---|
| cationic | A-1 | 30 | | | | | | | | 30 |
| epoxy | A-2 | | | | 50 | 40 | | | | |
| resin (A) | A-3 | | | | | | | 50 | | |
| | A-4 | | 30 | | | | 40 | | 45 | |
| | A-5 | | | 30 | | | | | | |
| cationic | B-1 | | 40 | 40 | 20 | 30 | 30 | 20 | 25 | 35 |
| acrylic | B-2 | 40 | | | | | | | | |
| resin (B) | B-3 | | | | | | | | | |
| | B-4 | | | | | | | | | |
| | B-5 | | | | | | | | | |
| | B-6 | | | | | | | | | |

| | | | | | | | | | |
|---|---|---|---|---|---|---|---|---|---|
| curing agent (C) | 30 | 30 | 30 | 30 | 30 | 30 | 30 | 30 | 35 |
| phenol structual part/ | 0.174 | 0.139 | 0.128 | 0.232 | 0.190 | 0.175 | 0.219 | 0.192 | 0.174 |
| 100 g of resin solid | | | | | | | | | |
| content (mole) | | | | | | | | | |
| dynamic glass | 116 | 114 | 108 | 112 | 116 | 108 | 105 | 105 | 120 |
| transition | | | | | | | | | |
| temperature (° C.) | | | | | | | | | |
| crosslink density | 1.2 | 1.2 | 1.2 | 1.2 | 1.2 | 1.2 | 1.2 | 1.2 | 1.5 |
| (×10−3 mol/cc) | | | | | | | | | |
| \|δA − δB\| | 0.2 | 0.2 | 0.2 | 0.2 | 0.2 | 0.2 | 0.2 | 0.2 | 0.2 |
| weather resistance | A | A | A | A | A | A | A | A | A |
| corrosion resistance | B | B | B | A | A | B | A | A | B |
| appearance of cured | A | A | A | A | A | A | A | A | A |
| electrodeposition | | | | | | | | | |
| coating film | | | | | | | | | |

TABLE 6

| | | Com. | Com. | Com. | Com. | Com. | Com. | Com. | Com. | Com. | Com. |
|---|---|---|---|---|---|---|---|---|---|---|---|
| | | example 1 | example 2 | example 3 | example 4 | example 5 | example 6 | example 7 | example 8 | example 9 | example 10 |
| cationic | A-1 | 20 | | 30 | 50 | | 60 | 30 | 30 | | 30 |
| epoxy | A-2 | | 40 | | | | | | | | |
| resin (A) | A-3 | | | | | | | | | | |
| | A-4 | | | | | 60 | | | | | |
| | A-5 | | | | | | | | | 30 | |
| cationic | B-1 | | | | | 10 | 10 | | | | |
| acrylic | B-2 | 50 | | | | | | | | | |
| resin (B) | B-3 | | 40 | 40 | 20 | | | 35 | | | |
| | B-4 | | | | | | | | 40 | | |
| | B-5 | | | | | | | | | 40 | |
| | B-6 | | | | | | | | | | 40 |

| | | | | | | | | | | |
|---|---|---|---|---|---|---|---|---|---|---|
| curing agent (C) | 30 | 20 | 30 | 30 | 30 | 30 | 35 | 30 | 30 | 30 |
| phenol structual part/ | 0.126 | 0.190 | 0.174 | 0.271 | 0.250 | 0.319 | 0.174 | 0.174 | 0.16 | 0.174 |
| 100 g of resin solid | | | | | | | | | | |
| content (mole) | | | | | | | | | | |
| dynamic glass | 112 | 107 | 100 | 116 | 96 | 132 | 92 | 116 | 112 | 116 |
| transition | | | | | | | | | | |
| temperature (° C.) | | | | | | | | | | |
| crosslink density | 1.5 | 0.6 | 1.2 | 1.2 | 1.2 | 1.2 | 1.5 | 1.2 | 1.2 | 1.2 |
| (×10−3 mol/cc) | | | | | | | | | | |
| \|δA − δB\| | 0.2 | 0.2 | 0.2 | 0.2 | 0.2 | 0.2 | 0.2 | 0.2 | 0.2 | 0.5 |
| weather resistance | A | A | A | C | C | C | A | A | A | A |
| corrosion resistance | C | C | C | A | C | A | C | A | A | A |
| appearance of cured | A | A | A | A | A | C | A | C | C | C |
| electrodeposition | | | | | | | | | | (cissing) |
| coating film | | | | | | | | | | |

Shown in the above tables, each of the cured electrodeposition coating film obtained in the examples had excellent weather resistance, in addition to excellent corrosion resistance. The evaluation standards “maximum irradiance level in acceptance is greater than or equal to MJ/m²” in the above evaluation of weather resistance corresponds to a strict standard in the art. The above table shows that the cured electrodeposition coating film according to the present invention extremely has excellent weather resistance such that the coating film can pass the strict standard.

Comparative example 1 included less amount of the cationic epoxy resin (A), which resulted in poor corrosion resistance.

Comparative example 2 included less amount of the blocked isocyanate curing agent (C), which resulted in low crosslink density and poor corrosion resistance.

Comparative example 3 included dynamic glass transition temperature of the cured electrodeposition coating film of less than 105° C., which resulted in poor corrosion resistance.

Comparative example 4 included phenol structural part in the cured electrodeposition coating film of greater than 0.24 mole, which resulted in poor weather resistance.

Comparative example 5 included phenol structural part in the cured electrodeposition coating film of greater than 0.24 mole and dynamic glass transition temperature of the cured electrodeposition coating film of less than 105° C., which resulted in poor corrosion resistance and poor weather resistance.

Comparative example 6 included phenol structural part in the cured electrodeposition coating film of greater than 0.24 mole and dynamic glass transition temperature of the cured electrodeposition coating film of greater than 120° C., which resulted in poor weather resistance and poor surface smoothness.

Comparative example 7 included dynamic glass transition temperature of less than 105° C., which resulted in poor corrosion resistance.

Comparative example 8 included a number average molecular weight of the cationic acrylic resin (B) of greater than 6000, which deteriorated smooth surface of the cured electrodeposition coating film.

Comparative example 9 included a glass transition temperature of the cationic acrylic resin (B) of greater than 50° C., which also deteriorated smooth surface of the cured electrodeposition coating film.

Comparative example 10 included difference between a solubility parameter 5A of the cationic epoxy resin (A) and a solubility parameter 5B of the cationic acrylic resin (B) being 0.5, which resulted in failure of coating film (so-called, cissing) in heating and curing.

### Example 10

### Formation of Multi Layered Coating Film

On the cured electrodeposition coating film obtained in example 1, an aqueous-type base coating composition (“AQUAREX AR-3100 BASE”, acryl-melamine resin type coating composition, commercially available from Nippon Paint Co., Ltd.) was applied by use of a air-spray so that a dry thickness was 12 μm, and preheated at 80° C. for 3 minutes. Then, clear top coating composition (“POLYURE EXCEL 0-3100 CLEAR”, Acrylic acid having urethane curing component-isocyanate type, commercially available from Nippon Paint Co., Ltd.) was applied on the uncured base coating film by use of a air-spray so that a dry thickness was 35 μm. The uncured base coating film and clear top coating film were baked at 140° C. for 30 minutes and cured simultaneously, to obtain a multi layered coating film having excellent film appearance.

The cured electrodeposition coating film according to the present invention is characterized by excellent corrosion resistance and excellent weather resistance. The cured electrodeposition coating film according to the present invention can be preferably used in a process for forming a multi layered coating film without applying an intermediate coating composition (so-called intermediate-coating-less system). It has advantages of cost-saving such as coating equipments, as well as decrease of CO₂ emission.

1. A cured electrodeposition coating film having a dynamic glass transition temperature of 105 to 120° C. and a crosslink density of 1.2×10⁻³ to 2.0×10⁻³ mole/cc, which is obtained by conducting electrodeposition coating with a cationic electrodeposition coating composition, and then heating and curing it, wherein
the cured electrodeposition coating film has phenol structural part represented with the formula: —C₆H₄—O— within a range of 0.12 to 0.24 mole in molar number based on a resin solid content of 100 g in the cured electrodeposition coating film,
the cationic electrodeposition coating composition comprises,
a cationic epoxy resin (A) having bisphenol A-type structure in its molecule,
a cationic acrylic resin (B) obtainable by reacting an amino group containing compound with a copolymer obtainable by radical-copolymerization of a hydroxy group containing monomer, a glycidyl group containing monomer and another monomer,
blocked isocyanate curing agent (C) which is obtained by blocking a cycloaliphatic isocyanate compound with an oxime compound, and
a pigment, and wherein
the cationic electrodeposition coating composition comprises 30 to 50 parts by weight of the cationic epoxy resin (A), 20 to 40 parts by weight of the cationic acrylic resin (B) and 30 to 35 parts by weight of the curing agent (C) in the ratio based on a resin solid content in the cationic electrodeposition coating composition,
the cationic epoxy resin (A) has a number average molecular weight of 2000 to 3000 and a glass transition temperature of 28 to 50° C., and the cationic acrylic resin (B) has a number average molecular weight of 5000 to 6000 and a glass transition temperature of 28 to 50° C., and
a solubility parameter δA of the cationic epoxy resin (A) and a solubility parameter δB of the cationic acrylic resin (B) have a relationship represented by the following formula:

|δA−δB|<0.3, and
a solubility parameter 6C of the blocked isocyanate curing agent (C) and the solubility parameters have a relationship represented by the following formulae:

|δC−δA|<1.0 and |δC−δB|<1.0.

2. The cured electrodeposition coating film according to claim 1, wherein the cationic epoxy resin (A) has phenol structural part represented with the formula: —C₆H₄—O— within a range of 0.35 to 0.55 mole in molar number based on a resin solid content of 100 g in the cationic epoxy resin (A).

3. The cured electrodeposition coating film according to claim 1, wherein the cationic electrodeposition coating composition further comprises 1 to 2 parts by weight of a silicate compound (D) based on the resin solid content of 100 g in the cationic electrodeposition coating composition.

4. A process for forming a multi layered coating film comprising the steps of:
applying a base coating composition on the cured electrodeposition coating film according to claim 1 to form an uncured base coating film,
applying a clear top coating composition on the uncured base coating film to form an uncured clear top coating film, and
simultaneously heating and curing the uncured base coating film and the uncured clear top coating film.

5. The cured electrodeposition coating film according to claim 2, wherein the cationic electrodeposition coating composition further comprises 1 to 2 parts by weight of a silicate compound (D) based on the resin solid content of 100 g in the cationic electrodeposition coating composition.

6. A process for forming a multi layered coating film comprising the steps of:
applying a base coating composition on the cured electrodeposition coating film according to claim 2 to form an uncured base coating film,
applying a clear top coating composition on the uncured base coating film to form an uncured clear top coating film, and
simultaneously heating and curing the uncured base coating film and the uncured clear top coating film.

7. A process for forming a multi layered coating film comprising the steps of:
applying a base coating composition on the cured electrodeposition coating film according to claim 3 to form an uncured base coating film,
applying a clear top coating composition on the uncured base coating film to form an uncured clear top coating film, and
simultaneously heating and curing the uncured base coating film and the uncured clear top coating film.

8. A process for forming a multi layered coating film comprising the steps of:
applying a base coating composition on the cured electrodeposition coating film according to claim 5 to form an uncured base coating film,
applying a clear top coating composition on the uncured base coating film to form an uncured clear top coating film, and
simultaneously heating and curing the uncured base coating film and the uncured clear top coating film.
